(19) United States
(12) Patent Application Publication
(10) Pub. No.: US 2017/0294801 A1
(43) Pub. Date: Oct. 12, 2017

(54) APPARATUS AND METHOD FOR CONTROLLING POWER GENERATON

(71) Applicant: Hyundai Motor Company, Seoul (KR)

(72) Inventors: Dae Kwang Kim, Yongin (KR); Geun Il Kim, Suwon (KR); Jeong Sung Kim, Daejeon (KR)

(21) Appl. No.: 15/351,757

(22) Filed: Nov. 15, 2016

(30) Foreign Application Priority Data
Apr. 8, 2016 (KR) 10-2016-0043543

(51) Int. Cl. H02J 7/14; B60L 11/18

(52) U.S. Cl. CPC H02J 7/1461; B60L 11/1809; B60L 11/1862

(57) ABSTRACT

A generation control apparatus of a vehicle is provided. The apparatus includes a battery use amount detection unit that accumulates charge and discharge currents of a battery to detect a battery use amount and that stores the battery use amount in a memory Additionally, a battery state detection unit detects a state of the battery and a controller determines a target charge amount that corresponds to a state of the battery based on the battery use amount. The controller further operates a generator for charging the battery based on the target charge amount, when starting of the vehicle is turned on.

### CROSS-REFERENCE TO RELATED APPLICATION

This application claims priority to and the benefit of Korean Patent Application No. 10-2016-0043543 filed in the Korean Intellectual Property Office on Apr. 8, 2016, the entire contents of which are incorporated herein by reference.

### BACKGROUND

(a) Field of the Invention

The present invention relates to an apparatus and method for controlling power generation, and more particularly, to an apparatus and method for controlling power generation of a vehicle.

(b) Description of the Related Art

A vehicle includes a battery that supplies power to various electric loads therein and a generator that supplies power that is generated while driving the vehicle to an electric load or to a charge power source of the battery. The vehicle increases a discharge amount of a battery for a predetermined time upon initial starting and operates the generator to maintain a charge amount of the battery. Such a control method may have a negative influence on durability of the battery by causing continuous battery discharge upon frequent starting of a vehicle. Further, due to a control method of charging a battery after increasing a discharge amount of the battery for a predetermined time after starting, upon frequent starting of the vehicle, the charge and discharge conversion number increases and thus, energy efficiency is also reduced.

The above information disclosed in this section is merely for enhancement of understanding of the background of the invention and therefore it may contain information that does not form the prior art that is already known in this country to a person of ordinary skill in the art.

### SUMMARY

The present invention provides an apparatus and method for controlling power generation having advantages of being capable of improving a life-span and energy efficiency of a battery by minimizing unnecessary battery discharge and charge and discharge conversion upon frequent starting of a vehicle.

An exemplary embodiment of the present invention provides a generation control apparatus of a vehicle that may include: a battery use amount detection unit configured to accumulate charge and discharge currents of a battery to detect a battery use amount and store the battery use amount in a nonvolatile memory; a battery state detection unit configured to detect a state of the battery; and a controller configured to determine a target charge amount that corresponds to a state of the battery based on the battery use amount and configured to operate the generator to charge the battery based on the target charge amount, when starting of the vehicle is turned on.

Another exemplary embodiment of the present invention provides a method of controlling power generation of a vehicle that may include: detecting a battery use amount by accumulating charge and discharge currents of a battery; storing the battery use amount in a nonvolatile memory; detecting a state of the battery; determining a target charge amount that corresponds to a state of the battery based on the battery use amount, when starting of the vehicle is turned on; and operating a generator for charging the battery based on the target charge amount. According to the present invention, upon frequent starting of a vehicle, by minimizing unnecessary battery discharge and charge and discharge conversion, a life-span and energy efficiency of a battery may be improved.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a block diagram illustrating a configuration of a generation control apparatus according to an exemplary embodiment of the present invention; and

FIG. 2 is a flowchart illustrating a method of controlling power generation of a vehicle according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention will be described more fully hereinafter with reference to the accompanying drawings in which exemplary embodiments of the invention are shown. As those skilled in the art would realize the described exemplary embodiments may be modified in various different ways all without departing from the spirit or scope of the present invention. The drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

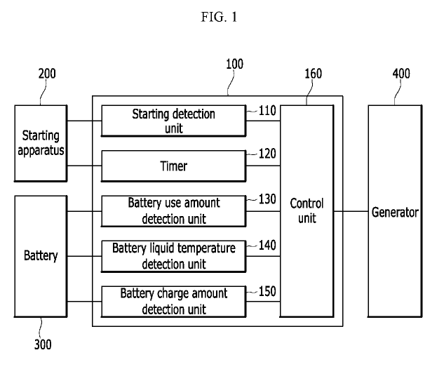

Hereinafter, an apparatus and method for controlling power generation according to an exemplary embodiment of the present invention will be described in detail with reference to necessary drawings. FIG. 1 is a block diagram illustrating a configuration of a generation control apparatus according to an exemplary embodiment of the present invention. Referring to FIG. 1, a generation control apparatus 100 according to an exemplary embodiment of the present invention may include a starting detection unit 110, a timer 120, a battery use amount detection unit 130, a battery liquid temperature detection unit 140, a battery charge amount detection unit 150, and a controller 160. The controller 160 may be configured to operate the various units of the apparatus.

Particularly, the starting detection unit 110 may be configured to monitor a starting apparatus 200 of the vehicle to detect starting on/off of the vehicle. The timer 120 may be configured to detect a time after starting of the vehicle is turned off. The battery use amount detection unit 130 may be configured to detect a use amount of a battery 300. The battery use amount detection unit 130 may be configured to accumulate an absolute value of a charging current and a discharge current of the battery 300 to detect a battery use amount. A battery use amount accumulated by the battery use amount detection unit 130 may be stored in a nonvolatile memory (not shown) to be continuously accumulated regardless of starting on/off of the vehicle. The battery liquid temperature detection unit 140 and the battery charge amount detection unit 150 may be configured to detect a battery state and detect a battery liquid temperature and a charge amount, respectively. The battery charge amount detection unit 150 may be configured to detect a charge amount of the battery 300. The controller 160 may be configured to execute general operations of the generation control apparatus 100.

Further, the controller 160 may be configured to activate or deactivate a timer based on a starting on/off state of the vehicle. When starting of the vehicle is turned off, the controller 160 may be configured to reset a timer value of the timer 120 and operate the timer 120. When starting of the vehicle is turned on, the controller 160 may be configured to stop the operation of the timer 120. Accordingly, when starting of the vehicle is turned off, a timer value of the timer 120 increases in proportional to a time, and when starting of the vehicle is turned on, the timer value stops increasing and maintains a present value. In other words, a timer value of the timer 120 corresponds to an elapsed time until restarting after starting of the vehicle is turned off.

When starting of the vehicle is turned on, the controller 160 may be configured to monitor a timer value of the timer 120 to determine whether the battery 300 is stabilized. When a timer value is equal to or greater than a predetermined battery stabilizing reference value, when sufficient time has elapsed after starting of the vehicle is turned off, the controller 160 may be configured to determine that the battery 300 enters a stabilizing state. In particular, a battery stabilizing reference value may be determined based on a specification of the battery 300 and may be set in a calibration process of the vehicle. For example, the battery stabilizing reference value may be in a range of about 3 hours to about 5 hours.

When a timer value of the timer 120 is greater than a battery stabilizing reference value, the controller 160 may be configured to reset a battery use amount accumulated by the battery use amount detection unit 130. A battery use amount accumulated by the battery use amount detection unit 130 may be used for monitoring a use amount of the battery 300 before the battery 300 is stabilized. Therefore, in response to determining that the battery 300 is stabilized by maintaining a starting off state of the vehicle for a predetermined period of time or longer, the controller 160 may be configured to reset an accumulated battery use amount.

For example, the predetermined period of time may be in a range of about 3 hours to about 5 hours.

Additionally, the controller 160 may be configured to select a target charge amount control map based on a battery use amount accumulated by the battery use amount detection unit 130. The target charge amount control map determines a target charge amount of the battery 300 based on a state of the battery 300 such as a liquid temperature and a charge amount. The target charge amount control map may be generated by mapping a corresponding target charge amount on a parameter value basis of parameters that have an influence on a target charge amount of the battery 300 such as a liquid temperature and a charge amount of the battery 300.

The controller 160 may be configured to compare a battery use amount accumulated by the battery use amount detection unit 130 with a predetermined threshold value and differently select a target charge amount control map based on a comparison result. For example, when an accumulated battery use amount is less than a threshold value, the controller 160 may be configured to select a target charge amount control map A. Further, for example, when an accumulated battery use amount is equal to or greater than a threshold value, the controller 160 may be configured to select a target charge amount control map B. The threshold value may be varied according to a charge state of the battery, and may be an available amount of the battery. For example, when a minimum limit of the available amount of the battery is 70% and a charge amount of the battery is 90%, the threshold value may be a charge amount of a battery corresponding to 20%. If a capacity of the battery is 80 Ah, the threshold value may be 16 Ah.

In the target charge amount control maps A and B, different target charge amounts are mapped to the same battery state (e.g., liquid temperature, charge amount). For example, in the target charge amount control map A, a lower target charge amount is mapped to the same battery state, compared with a target charge amount control map B. When a battery use amount accumulated by the battery use amount detection unit 130 is less than a threshold value, the controller 160 may be configured to determine that a use amount of the battery 300 may increase. Therefore, to acquire a target charge amount, the controller 160 may be configured to select a target charge amount control map A.

When a battery use amount accumulated by the battery use amount detection unit 130 is equal to or greater than a threshold value, the controller 160 may be configured to determine that a charge amount calculation error of the battery 300 may increase and that durability of the battery 300 may reduce due to increased battery use when the battery 300 is not stabilized. Therefore, for acquisition of a target charge amount, the controller 160 may be configured to select a target charge amount control map B.

When a target charge amount control map is selected, the controller 160 may be configured to acquire a target charge amount of the battery 300 based on the selected target charge amount control map. The controller 160 may be configured to determine a target charge amount that corresponds to a present state (e.g., liquid temperature, charge amount) of the battery 300 based on the selected target charge amount control map. When a target charge amount is determined, the controller 160 may be configured to compare the target charge amount with a present charge amount of the battery 300.

When a present charge amount of the battery 300 is equal to or greater than a target charge amount, the controller 160 may be configured to discharge the battery 300 to cause a charge amount of the battery 300 to approach a target charge amount. When a present charge amount of the battery 300 is less than a target charge amount, the controller 160 may be configured to drive or operate a generator 400 to charge the battery 300 to cause a charge amount of the battery 300 to approach a target charge amount. In other words, when a present charge amount of the battery 300 is less than a target charge amount, the controller 160 may be configured to adjust a current or a voltage of the generator 400 to cause a charge amount of the battery 300 to approach a selected target charge amount.

In the generation control apparatus 100 of the foregoing structure, the starting detection unit 110, the timer 120, the battery use amount detection unit 130, the battery liquid temperature detection unit 140, the battery charge amount detection unit 150, and the controller 160 may be performed by a processor implemented with at least one central processing unit (CPU) or other chipset and microprocessors.

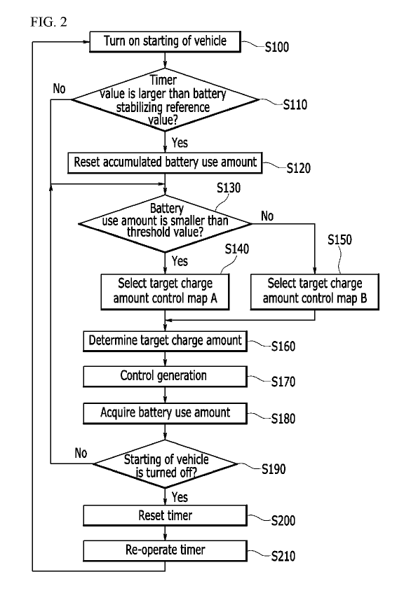

FIG. 2 is a flowchart illustrating a method of controlling power generation of a vehicle according to an exemplary embodiment of the present invention. A method of controlling power generation of a vehicle that is described with reference to FIG. 2 may be performed by the controller of the generation control apparatus 100 of FIG. 1. Referring to FIG. 2, when starting of the vehicle is turned on (S100), the generation control apparatus 100 according to an exemplary embodiment of the present invention may be configured to stop the timer 120 and compare a present timer value with a predetermined battery stabilizing reference value (S110).

When a timer value is greater than a battery stabilizing reference value, the generation control apparatus 100 may be configured to determine that starting of the vehicle is turned on when the battery 300 is stabilized. Accordingly, the generation control apparatus 100 may be configured to reset a battery use amount accumulated thus far by the battery use amount detection unit 130 (S120). When a timer value is equal to or less than a battery stabilizing reference value, the generation control apparatus 100 may be configured to determine that the vehicle is restarted before the battery 300 is stabilized. Accordingly, the generation control apparatus 100 may be configured to compare a battery use amount accumulated thus far (e.g., until now) by the battery use amount detection unit 130 with a threshold value (S130).

When an accumulated battery use amount is less than a threshold value, the controller 160 may be configured to select a target charge amount control map A (S140). When an accumulated battery use amount is equal to or greater than a threshold value, the controller 160 may be configured to select a target charge amount control map B (S150). When any one target charge amount control map is selected through step S140 or 5150, the controller 160 may be configured to determine a target charge amount that corresponds to a present battery state using the selected target charge amount control map (S160). Further, the controller 160 may be configured to operate the generator 400 based on the determined target charge amount (S170).

In particular, the controller 160 may be configured to operate the generator 400 based on a comparison result of a present charge amount of the battery 300 and a target charge amount at step S170. When a present charge amount of the battery 300 is less than a target charge amount, the controller 160 may be configured to operate the generator 400 to charge the battery 300 to cause a charge amount of the battery 300 to approach a target charge amount. When a present charge amount of the battery 300 is greater than a target charge amount, the controller 160 may be configured to determine that discharge of the battery 300 is required and operate the generator 400 to stop charging the battery 300.

When a charging current or a discharge current of the battery 300 occurs through a generator operation at step S170, the controller 160 may be configured to accumulate the charging current or the discharge current and acquire a battery use amount (S180). The battery use amount acquired at step S180 may be stored in a nonvolatile memory (not shown), and a value thereof may be maintained regardless of the starting on or off of the vehicle. The controller 160 may be configured to determine whether starting of the vehicle is turned off (S190), and until starting of the vehicle is turned off, the process may repeatedly perform steps S130 to S180 and the generation control apparatus 100 may be configured to continue accumulating a battery use amount. Further, the generation control apparatus 100 may be configured to determine a target charge amount based on an accumulated battery use amount and adjust charge and discharge of the battery 300 using the target charge amount.

When starting of the vehicle is turned off at step S190, the generation control apparatus 100 may be configured to reset the timer 120 (S200) and re-operate the timer 120 (S210). The timer 120 may be operated by the controller until the starting of the vehicle is again turned on, and a timer value increases in proportional to an elapsed time after starting of the vehicle is turned off. Accordingly, the generation control apparatus 100 may be configured to determine whether starting of the vehicle is maintained as a turned off state for which time using a timer value and may be configured to determine whether the battery 300 is stabilized based on the timer value.

According to the foregoing exemplary embodiment, the generation control apparatus 100 may be configured to accumulate a battery use amount before the battery 300 is stabilized and determine a target charge amount of the vehicle when starting of the vehicle is turned on based on the accumulated battery use amount. The generation control apparatus 100 may further be configured to discharge the battery 300 based on the determined target charge amount or may be configured to operate the generator 400 to charge the battery 300. In such an exemplary embodiment, by minimizing charge and discharge conversion upon frequent starting, fuel consumption may be enhanced, compared with an existing method that adjusts charge and discharge of the battery 300 by a fixed pattern when starting of the vehicle is turned on. Further, compared with an existing method, discharge occurring due to frequent starting may be minimized and thus a battery life-span may be enhanced.

According to another exemplary embodiment, the number of target charge amount maps using in the generation control apparatus 100 may be two or more. In particular, the generation control apparatus 100 may be configured to divide a corresponding battery use 11 amount into a plurality of areas and may be configured to select a corresponding target charge amount map based on an area in which an accumulated battery use amount is included.

Further, according to another exemplary embodiment, the generation control apparatus 100 may use a method of differently setting a weight value that is added to a target charge amount based on a battery use amount instead of differently using a target charge amount map based on a battery use amount. In particular, the generation control apparatus 100 may be configured to calculate a target charge amount based on a battery state and may be configured to add a weight value based on an accumulated battery use amount to a target charge amount to determine a final target charge amount.

A method of controlling power generation by the foregoing exemplary embodiment may be executed through software. When being executed with software, constituent means of the present invention are code segments that execute a necessary work. A program or code segments may be stored in a processor readable medium or may be transmitted by a computer data signal that is coupled to a carrier in a transmission medium or a communication network.

A computer readable recording medium includes an entire type of record device that stores data that may be read by a computer system. A computer readable recording device may include, for example, a Read-Only Memory (ROM), a Random-Access Memory (RAM), a Compact Disc-ROM (CD-ROM), a Digital Versatile Disk-ROM (DVD_ROM), a Digital Versatile Disk-RAM (DVD_RAM), a magnetic tape, a floppy disk, a hard disk, and an optical data storage. Further, in the computer readable recording medium, codes that are distributed in a computer system connected to a network and in which a computer may read with a distributed method may be stored and executed.

The foregoing drawings and a detailed description of the invention are an illustration of the present invention and are used for describing the present invention but are not used for a meaning limitation or for limiting the scope of the present invention described in the claims. Therefore, the foregoing drawings and the detailed description may be easily selected and replaced by a person of ordinary skill in the art. Further, a person of an ordinary skill in the art may omit some of constituent elements described in this specification without degradation of a performance or may add constituent elements to enhance a performance. In addition, a person of an ordinary skill in the art may change the order of method steps that are described in this specification according to a process environment or equipment. Therefore, the scope of the present invention should be determined by the appended claims and their equivalents instead of a described implementation.

### DESCRIPTION OF SYMBOLS

100: generation control apparatus

110: starting detection unit

120: timer

130: battery use amount detection unit

140: battery liquid temperature detection unit

150: battery charge amount detection unit

160: controller

200: starting apparatus

300: battery

400: generator

What is claimed is:

1. A generation control apparatus of a vehicle, comprising:
a battery use amount detection unit configured to accumulate charge and discharge currents of a battery to detect a battery use amount and store the battery use amount in a memory;
a battery state detection unit configured to detect a state of the battery; and
a controller configured to determine a target charge amount that corresponds to a state of the battery based on the battery use amount and operate a generator for charging the battery based on the target charge amount, when starting of the vehicle is turned on.

2. The generation control apparatus of claim 1, further comprising:
a plurality of target charge amount control maps that correspond different target charge amounts to the same battery state,
wherein the controller is configured to select one of the plurality of target charge amount control maps based on the battery use amount and determine a target charge amount that corresponds to a state of the battery based on the selected target charge amount control map.

3. The generation control apparatus of claim 1, wherein the controller is configured to collect a weight value based on the battery use amount and apply the weight value to a target charge amount that corresponds to a state of the battery to determine a target charge amount.

4. The generation control apparatus of claim 1, wherein the controller is configured to reset the battery use amount, when a starting off state of the vehicle is maintained for a predetermined period of time or longer.

5. The generation control apparatus of claim 4, further comprising:
a timer configured to increase a timer value to correspond to a holding time of a starting off state of the vehicle,
wherein the controller is configured to reset the battery use amount when the timer value is equal to or greater than a reference value.

6. The generation control apparatus of claim 1, wherein the controller is configured to operate the battery based on a comparison result of a present charge amount and the target charge amount of the battery.

7. The generation control apparatus of claim 6, wherein the controller is configured to operate the generator to charge the battery when a present charge amount of the battery is less than the target charge amount.

8. A method of controlling power generation of a vehicle, comprising:
detecting, by a controller, a battery use amount by accumulating charge and discharge currents of a battery;
storing, by the controller, the battery use amount in a memory;
detecting, by the controller, a state of the battery;
determining, by the controller, a target charge amount that corresponds to a state of the battery based on the battery use amount, when starting of the vehicle is turned on; and
operating, by the controller, a generator for charging the battery based on the target charge amount.

9. The method of claim 8, wherein the determining of a target charge amount includes:
selecting, by the controller, one of a plurality of target charge amount control maps according to the battery use amount; and
determining, by the controller, a target charge amount that corresponds to a state of the battery based on the selected target charge amount control map,
wherein in the plurality of target charge amount control maps, different target charge amounts are mapped to the same battery state.

10. The method of claim 8, wherein the determining of a target charge amount includes:
selecting, by the controller, a weight value based on the battery use amount; and
determining, by the controller, a target charge amount by applying the weight value to a target charge amount that corresponds to a state of the battery.

11. The method of claim 8, further comprising:
resetting, by the controller, the battery use amount, when a starting off state of the vehicle is maintained for a predetermined period of time or longer.

12. The method of claim 11, further comprising:
increasing, by the controller, a timer value to correspond to a holding time of a starting off state of the vehicle,
wherein the resetting of the battery use amount includes resetting, when the timer value is equal to or greater than a reference value, the battery use amount.

13. The method of claim 8, wherein the operating of a generator includes operating the generator to charge the battery when a present charge amount of the battery is less than the target charge amount.
